(19) United States
(12) Patent Application Publication
(10) Pub. No.: US 2019/0392224 A1
(43) Pub. Date: Dec. 26, 2019

(54) IDENTIFICATION AND USE OF ATTRACTORS IN CROWD CONTROL

(71) Applicant: Xinova, LLC, Seattle, WA (US)

(72) Inventor: Ezekiel KRUGLICK, Poway, CA (US)

(73) Assignee: Xinova, LLC, Seattle, WA (US)

(21) Appl. No.: 16/489,958

(22) PCT Filed: Mar. 17, 2017
(86) PCT No.: PCT/US17/22921

§ 371 Date: Aug. 29, 2019

(51) Int. Cl. G06K 9/00; H04N 7/18; G06F 3/14

(52) U.S. Cl. CPC G06K 9/00778; G06K 9/00335; G06F 3/14; H04N 7/181

(57) ABSTRACT

Technologies are generally described for identification and use of attractors in crowd control. In some examples, social forces associated with individuals within a crowd may be extracted from a crowd model. One or more attractors may then be determined from the social forces, where an attractor is an individual that other crowd members tend to follow. The determined attractors may then be used to guide the overall flow of the crowd.

### BACKGROUND

Unless otherwise indicated herein, the materials described in this section are not prior art to the claims in this application and are not admitted to be prior art by inclusion in this section.

Events that draw crowds of people, such as concerts, conventions, and similar, may involve crowd control planning. For example, security personnel and/or signage may be positioned around or within the event area to provide guidance and direction to individuals within the crowds. In some situations, it may be difficult to provide successful crowd guidance and direction, especially if the crowd is large.

### SUMMARY

The present disclosure generally describes techniques to identify and utilize attractors in crowd control through crowd modeling and social force extraction.

According to some examples, a method is provided to detect and use attractors in crowd control. The method may include receiving a crowd model for a crowd, extracting a social force for one or more pairs of individuals within the crowd from the crowd model, evaluating extracted social forces for one or more individuals in the crowd, and comparing the evaluated social forces for the one or more individuals in the crowd. The method may further include determining a subset of individuals in the crowd as attractors based on the comparison and providing one or more images of the crowd to be displayed, where the attractors are indicated in the one or more images.

According to other examples, a system is provided to detect and use attractors in crowd control. The system may include a first server, where the first server includes a communication module configured to exchange data with one or more computing devices, a memory configured to store instructions, and a processor coupled to the communication module and the memory. The processor may be configured to execute a crowd control application in conjunction with the instructions stored in the memory. The crowd control application may be configured to receive a crowd model for a crowd and iteratively extract a social force for one or more pairs of individuals within the crowd from the crowd model. The crowd control application may be further configured to determine a subset of individuals in the crowd as attractors based on a comparison of a sum of extracted social forces for one or more individuals in the crowd and provide one or more images of the crowd to be displayed, where the attractors are indicated in the one or more images.

According to further examples, a crowd control system configured to provide detection and use of attractors in crowd control is provided. The system may include multiple monitoring devices configured to capture images of a crowd. The system may further include a server configured to receive barrier information, crowd member information, and location information associated with the crowd and an environment of the crowd. The server may be further configured to generate a crowd model based on the received barrier information, crowd member information, and location information, where the crowd model includes a social force for one or more individuals in the crowd. The server may be further configured to extract the social force for one or more pairs of individuals within the crowd from the crowd model, determine a subset of individuals in the crowd as attractors based on a comparison of a sum of extracted social forces for the one or more individuals in the crowd, and provide one or more images of the crowd to be displayed, where the attractors are tagged in the one or more images.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 includes a conceptual illustration of an example crowd with followers, stragglers, and attractors;

FIG. 2 illustrates an example crowd monitoring and control system configured to identify and utilize attractors in crowd control;

FIG. 3 illustrates conceptually how attractors can be guided by a system configured to identify and utilize attractors in crowd control;

FIG. 4 illustrates major components of an example system configured to identify and utilize attractors in crowd control;

FIG. 5 illustrates a general purpose computing device, which may be used to identify and utilize attractors in crowd control;

FIG. 6 is a flow diagram illustrating an example method to identify and utilize attractors in crowd control that may be performed by a computing device such as the computing device in FIG. 5; and

FIG. 7 illustrates a block diagram of an example computer program product, some of which are arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and/or computer program products related to identification and use of attractors in crowd control.

Briefly stated, technologies are generally described to identify and utilize attractors in crowd control. In some examples, social forces associated with individuals within a crowd may be extracted from a crowd model. One or more attractors may then be determined from the social forces, where an attractor is an individual that other crowd members tend to follow. The determined attractors may then be used to guide the overall flow of the crowd.

A crowd model of a crowd may provide or be used to determine one or more attractors in order to guide the crowd or groups within the crowd. The crowd model may include representations of individuals in the crowd and parameters that define how interactions between the individuals (i.e., social forces that define a desire of individuals to follow or stay away from certain other individuals) and external factors such as obstacles in the crowd's path or desired directions for the crowd. The crowd model may include one or more of a number of individuals, a direction of each individual, a speed of each individual, a density of the individuals within the crowd, and comparable crowd parameters. Visibility, direction of movement, surroundings of the crowd such as barriers, and similar parameters may also be taken into account in the crowd model.

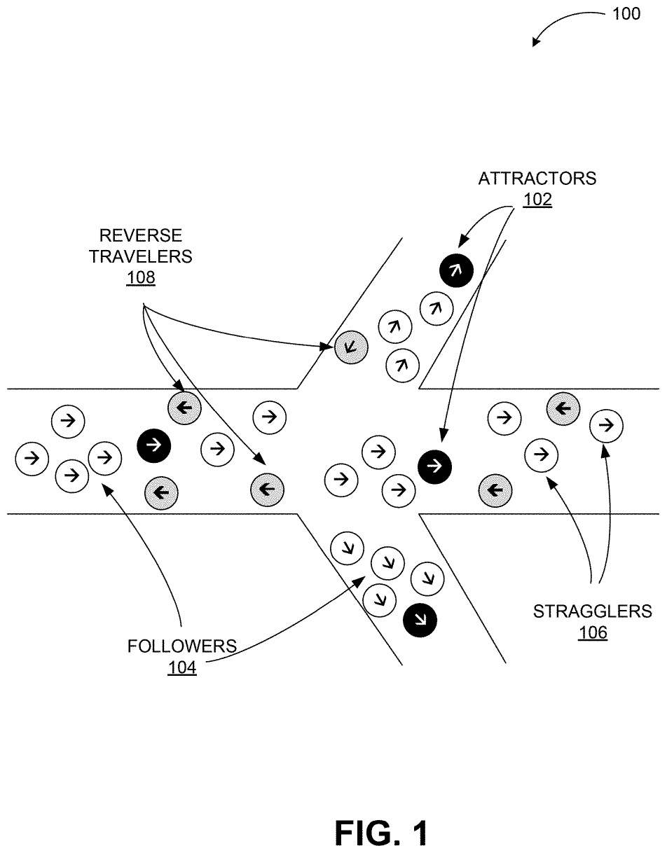

FIG. 1 includes a conceptual illustration of an example crowd with followers, stragglers, and attractors, arranged in accordance with at least some embodiments described herein.

FIG. 1 depicts a crowd 100 with a number of individuals (e.g., persons). In situations where the crowd 100 or portions of the crowd 100 are mobile, a movement of some or all of the individuals within the crowd 100 may allow the individuals to be categorized as one of several different types. For example, individuals within the crowd 100 may be categorized as attractors 102, followers 104, stragglers 106, or reverse travelers 108 among other potential categories. The attractors 102 may include individuals that other individuals within the crowd 100 tend to follow. The attractors 102 may move based on the movements of other attractors or individuals in the crowd 100 and/or may move based on some other stimuli. The followers 104 may include individuals that tend to follow one or more other individuals in the crowd 100, such as one or more of the attractors 102. The stragglers 106 may include individuals that also tend to follow one or more individuals within the crowd 100, similar to the followers 104, but at a greater distance or with less focus than the followers 104. The reverse travelers 108 may include individuals whose movements tend to oppose those of the majority of the individuals in the crowd 100. In some embodiments, the reverse travelers 108 themselves may also be categorized into or as attractors, followers, and/or stragglers among other potential categories.

The categorization of individuals within the crowd 100 may be dynamic over time and space. For example, an individual categorized as an attractor at a first time and location may be categorized as a follower at a later time or at a different location. Similarly, an individual categorized as a follower at a first time and location may be categorized as an attractor at a later time or at a different location.

Crowds such as the crowd 100 may flow or move in self-organized groups, where at least some of the groups include at least one of the attractors 102 and one or more of the followers 104. For relatively large crowds, not all of the attractors 102, for example those located in the interior of the crowd and unable to observe exterior signage or determine what is happening, may know where they are going or should be going. If left unguided, groups with such attractors may interfere with other groups, impeding overall crowd flow or causing crowd portions to move into dead ends or blockaded positions. In situations where relatively efficient and fast crowd movement is desired, such as emergencies or evacuations, such interference may cause injuries and even death. In some embodiments, attractor identification and guidance techniques may be used to control crowd flow, thereby mitigating potential interference between different groups.

A crowd as used herein refers to a group of individuals generally moving in a similar direction. In some examples, a group of individuals in a general geographic area may include multiple crowds, that is, different sub-groups moving in different directions. While crowds of people are used as illustrative examples herein, embodiments are not limited to controlling crowds of people. Other crowds such as herds of animals, groups of self-propelled robotic machines, and comparable ones may also be controlled through a crowd monitoring and control system configured to identify and utilize attractors in crowd control using the principles described herein.

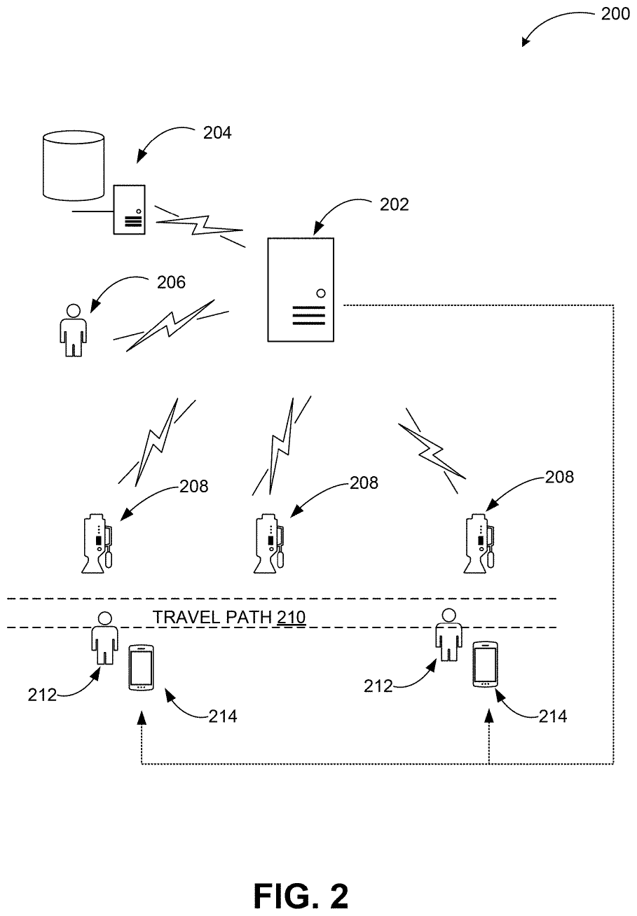

FIG. 2 illustrates an example crowd monitoring and control system 200 configured to identify and utilize attractors in crowd control, arranged in accordance with at least some embodiments described herein.

The crowd monitoring and control system 200 may be configured to monitor one or more travel paths 210 where individuals and crowd members may be expected to pass through, and may also be configured to monitor areas, locations, or spaces within which crowds are expected to gather. The travel paths 210 may be of any configuration and are only shown here as a single straight path for simplicity. The crowd monitoring and control system 200 may include a server 202 configured to manage the crowd monitoring and control system 200. The server 202 may be configured to communicate with at least one remote server 204, which may in turn communicate with one or more databases or other remote devices or systems. For example, the remote server 204 may be configured to provide map data about the travel paths 210, event location, and/or expected crowd gathering areas, or may be configured to provide information about event attendees or expected event attendees. The server 202 may also be configured to communicate with one or more external entities 206. The external entities 206 may include individuals within a crowd and/or other authorities such as police officers and similar.

The crowd monitoring and control system 200 may further include one or more image or video capture devices 208 coupled to the server 202. The capture devices 208 may be oriented toward the travel paths 210, and may be configured to record image and/or video data associated with the travel paths 210 and/or other monitored areas and transmit the recorded data to the server 202. The capture devices 208 may be stationary (for example, mounted to one or more structures) or mobile (for example, mounted to a vehicle or carried by security personnel).

The crowd monitoring and control system 200 may also include one or more display or notification devices 214 coupled to the server 202. The notification devices 214 may be associated with security personnel 212, particular locations along the travel paths 210 or the monitored areas, and/or individuals associated with the travel paths 210. The notification devices 214 may be configured to receive notification data from the server 202 and display the notification data to the security personnel 212, individuals associated with the travel paths 210, and/or other personnel or individuals associated with the crowd monitoring and control system 200. In some embodiments, the notification devices 214 may also transmit data to the server 202. For example, an individual notification device may transmit location data to the server 202 indicating the location of the notification device and/or associated security personnel. The notification devices 214 may also be configured to record image and/or video data associated with the travel paths 210 and transmit the recorded data to the server 202. The notification devices 214 may also be configured to transmit additional information such as device orientation or other device data.

In some embodiments, the crowd monitoring and control system 200 may be configured to identify and utilize attractors within crowds located in or along the travel paths 210. For example, the capture devices 208 and/or the notification devices 214 may transmit video data associated with crowds located in or along the travel paths 210. The capture devices 208 and/or the notification devices may then transmit the video data to the server 202. The server 202, in conjunction with the remote server 204, may then use the video data to generate and/or update a model of the crowds and identify attractors within the crowds based on the model of the crowds. The server 202 may then provide notification data indicating the identified attractors to the notification devices 214, which in turn display the notification data to the security personnel 212 and/or to individuals in the crowds.

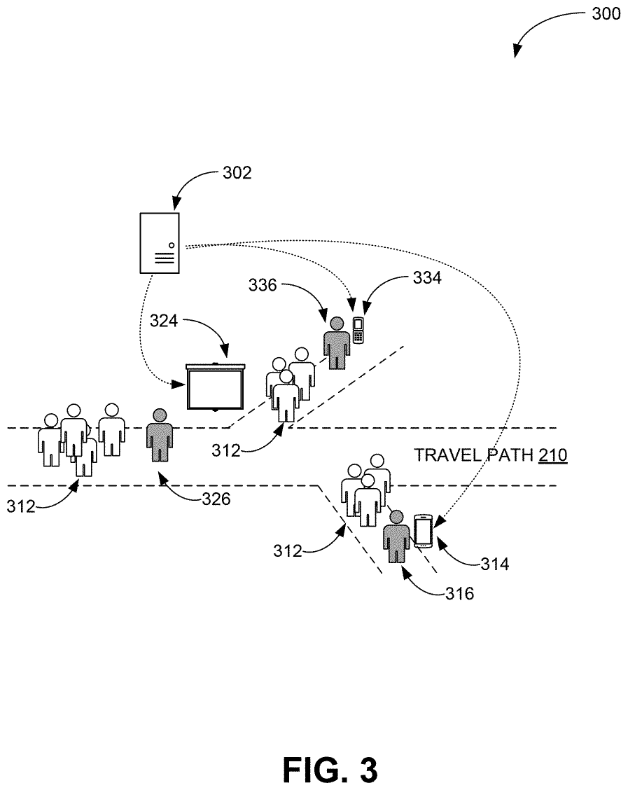

FIG. 3 illustrates conceptually how attractors can be guided by a system configured to identify and utilize attractors in crowd control, arranged in accordance with at least some embodiments described herein.

As shown in a diagram 300, a crowd monitoring and control system 302 configured to monitor and control a crowd 312 along the travel paths 210 may be similar to the crowd monitoring and control system 200. For example, the crowd monitoring and control system 302 may include a server, which may be similar to the server 202 in FIG. 2, and may further include one or more remote servers (for example, the remote server 204), connections to remote servers, connections to external entities (for example, the external entities 206), databases, and/or image or video capture devices (for example, the capture devices 208). The crowd monitoring and control system 302 may be configured to determine a crowd model or receive a crowd model from a remote server (for example, the remote server 204) or another external entity, for example based on captured image and/or video data associated with the travel paths 210 and/or the crowd 312. The crowd monitoring and control system 302 may then use the captured data to generate and/or update a crowd model, similar to the server 202 described above, and may then identify attractors associated with the crowd 312 based on the crowd model.

The crowd monitoring and control system 302 may then provide notification data indicating identified attractors to notification devices, such as mounted displays, smartphones, tablet computers, augmented reality devices, wearables or wearable computers, or any device suitable to display notification information. For example, the crowd monitoring and control system 302 may provide notification data to a public display 324, a smartphone 314, and/or a portable display 334. In some embodiments, the notification data may include image and/or video data of the crowd 312 in which identified attractors are tagged or otherwise indicated, identified, or marked. The notification data may also include suggested guidance instructions to be provided to the tagged attractors. For example, the guidance instructions may indicate that a particular attractor should proceed in a particular direction and/or with a particular speed or at a particular pace. In some embodiments, the guidance instructions may be provided by an administrator with access to the crowd model and/or images of the crowd captured by the capture devices 208.

In some embodiments, a notification device may be associated with one or more security personnel. For example, the public display 324 may be associated with security personnel 326, the smartphone 314 may be associated with security personnel 316, and the portable display 334 may be associated with security personnel 336. The security personnel, upon viewing the notification data presented on the various notification devices, may then provide guidance to the attractors identified in the notification data, based on suggested guidance instructions in the notification data and/or some other criteria. For example, the security personnel 326 may be able to identify one or more nearby attractors within the crowd 312 based on the notification data presented on the public display 324, and may instruct the identified attractor(s) to proceed along the travel paths 210 with a particular speed. The notification may include, for example, identification or highlighting of the attractor(s) on a still image or video of the crowd.

As another example, the security personnel 316 may be able to identify nearby attractor(s) within the crowd 312 based on the notification data presented on the smartphone 314, and may instruct the identified attractor(s) to reverse direction in order to move along the travel paths 210. The attractor(s) may be highlighted or otherwise identified on a still image or video of the crowd as in the public display example or their identifying features (clothing items, height, hair color, etc.) may be provided to the security personnel 316. Similarly, the security personnel 336 may be able to use the notification data presented on the portable display 334 to identify nearby attractor(s) within the crowd 312 and direct the identified attractor(s) toward the travel paths 210. Accordingly, by causing the security personnel 326, 316, and 336 to influence a relatively few number of individual attractors in the crowd 312, the crowd monitoring and control system 302 may be able to guide the flow and movement of a majority of or even the entire crowd 312 along the travel paths 210.

In some embodiments, the notification data may be presented directly to attractors in the crowd 312. For example, the public display 324 may present notification data that indicate particular individual attractors in the crowd 312 to the crowd 312, and may provide directions, instructions, and/or guidance to those attractors. Various techniques such as laser pointers or projections may also be included to help point out the specific member(s) of the crowd being addressed.

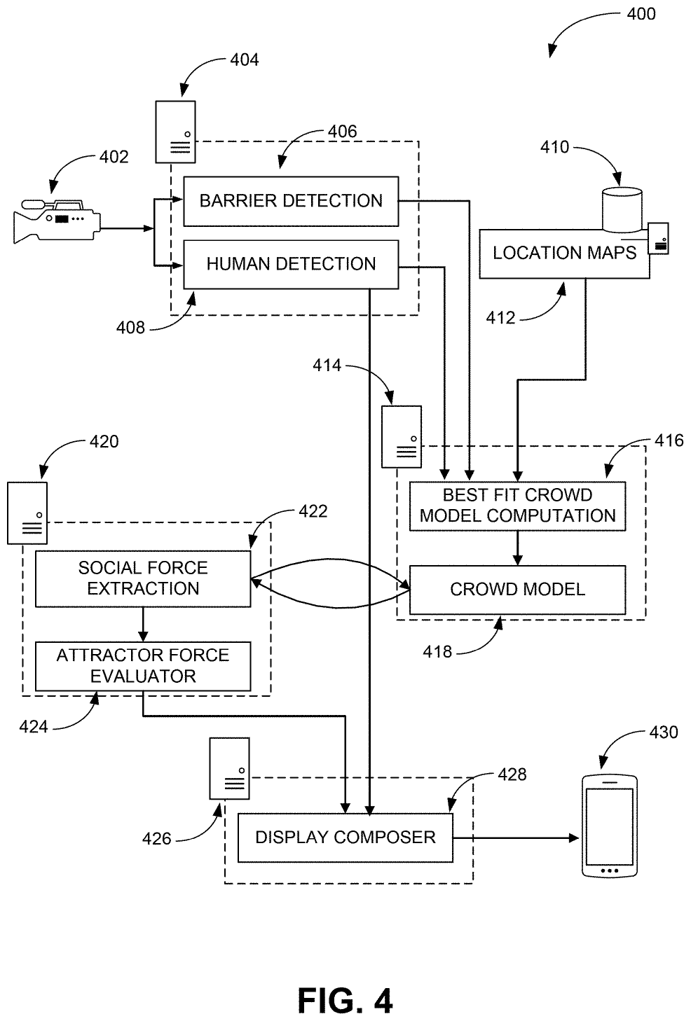

FIG. 4 illustrates major components of an example system 400 configured to identify and utilize attractors in crowd control, arranged in accordance with at least some embodiments described herein.

The system 400 may be similar to the crowd monitoring and control system 200 described above, and may be configured to monitor one or more travel paths and/or areas within which crowds are expected to gather. The system 400 may include at least one video capture device 402 configured to capture video data associated with the monitored travel path(s), area(s), and/or associated individuals or crowds. The video capture device(s) 402 may transmit the video data to a first server 404. The first server 404 may be configured to receive the video data and identify visible physical barriers and crowd members. For example, the first server 404 may implement a barrier detection module 406 configured to identify physical barriers such as walls, columns, or other obstacles to movement in the video data, thereby generating barrier information. Barriers and other obstacles may also be determined based on prior knowledge, for example, by aligning the video data or still images to map data for particular locations. The first server 404 may also implement a human detection module 408 configured to identify individuals or the crowd members in the video data. For example, the human detection module 408 may use computer vision features to detect features in the video data, and may identify the features as particular individuals or crowd members, thereby generating crowd member information. In some cases, the modules may assist each other, for example with the human detection aiding the barrier detection by allowing deduction of places humans are not moving through.

The server 404 may then transmit the barrier information from the barrier detection module 406 and the crowd member information from the human detection module 408 to a server 414. The server 414 may be configured to generate a crowd model 418 based on the barrier information and the crowd member information from the server 404 and optionally the video data captured by the video capture device(s) 402. In some embodiments, the server 414 may also receive location maps data 412 and other location-specific data from a map database 410, which may be local to the server 414, remote to the server 414, and/or on a remote server. The location maps data 412 may include information about the travel paths and/or areas monitored by the system 400, and the other location-specific data may include information about the identity and estimated locations and movement of event attendees, security personnel, and/or other individuals expected to be within the monitored travel paths and areas.

In some embodiments, the server 414 may generate the crowd model 418 using one or more statistical approaches. For example, a best-fit crowd model computation module 416 may be configured to receive the barrier information and the crowd member information from the server 404 and optionally the video data captured by the video capture device(s) 402 and use the received information and data to generate a moving crowd model based on mathematically-determined best-fit evaluations. A best-fit approach compares measured or otherwise determined values to a mathematical or statistical formula and arrives in a mathematical model for the measured or otherwise determined data. For example, the best-fit crowd model computation module 416 may generate the crowd model 418 based on a key agent equation that describes the overall force causing an individual within the crowd to move. The overall force may be based on a self-drive force associated with the desired destination of the individual, one or more interaction forces based on the interaction between the individual and other individuals in the crowd, and a barrier force based on the interaction between the individual and physical barriers in the area. The interaction forces may be further broken down into mechanical crowd forces (for example, physical forces due to interaction with other individuals, such as via pushing) and social interaction forces (for example, a desire of the individual to follow or stay away from certain other individuals). In some embodiments, the key agent equation may have the form:

$${f}_{i} = {f}_{i}^{S} + {\sum }_{j = 1 \\ i \neq j}^{N} {f}_{ij}^{I} + {\sum }_{k = 1}^{M} {f}_{ik}^{W} ,$$

where fᵢ is a sum of forces acting on the ith individual, fᵢ^{S} is a self-drive force of the ith individual, fᵢⱼ^{I} is an interactive force applied to the ith individual by other individuals in the crowd, iteratively summed for all individuals interacting with the ith individual, and fᵢₖ^{W} is a barrier force applied to the ith individual by natural and synthetic barriers in the environment of the crowd, iteratively summed for all barriers. Thus, for an attractor, the sum of interactive forces by other individuals may have a high (or highest) value but the force is an attraction force, that is, in opposite direction of the other terms in the equation.

The best-fit crowd model computation module 416 may be able to derive the mechanical interaction forces and the barrier forces based on the barrier information and the crowd member information from the server 404 and optionally the video data captured by the video capture device(s) 402. The best-fit crowd model computation module 416 may derive the self-drive force from overall crowd paths and dynamics indicated by the crowd member information and the captured video data, and may derive the social interaction forces using a best-fit model. In some embodiments, the best-fit crowd model computation module 416 may derive the key agent equation for most or all crowd members in a region of the crowd order to generate the crowd model 418, using video analysis inputs (for example, the captured video data) for barrier and contact forces and heuristics to identify crowd destinations of interest. As crowds may change over time, the best-fit crowd model computation module 416 may be configured to update or regenerate the crowd model 418 periodically or dynamically based on crowd conditions. For example, crowd conditions may change based on whether attractors in the crowd comply with previously-provided instructions. The compliance (or non-compliance) of the attractors may be reflected in the captured video data and/or feedback from security personnel or other personnel, and may be used by the best-fit crowd model computation module 416 to update the crowd model 418.

The server 414 may then transmit or make the generated crowd model 418 available to a server 420 configured to use the crowd model 418 to identify crowd attractors, described above. In some embodiments, the server 420 may be configured to identify crowd attractors by extracting the social interaction forces from the best-fit crowd model computation from module 416 and summing or otherwise evaluating the social interaction forces for one or more individuals in the crowd. Accordingly, in some embodiments the server 420 may implement a social force extraction module 422 configured to extract the social interaction forces in the crowd model 418 and an attractor force evaluator module 424 configured to sum, collect, or otherwise evaluate the extracted social interaction forces for individuals. The server 420 may then use the social interaction forces to identify attractors, which may be those individuals with a social interaction force that is above a predefined threshold under one or more various forms of evaluation (e.g., summation, weighted summation, averaging, sum of forces that meet certain criteria, etc.). In some examples, a single attractor may be selected (e.g., one with the highest attractive social interaction force). In other embodiments, multiple attractors may be selected based on factors such as crowd size, area size, fluidity of the crowd, etc. For example, a large crowd (or area) may be divided into portions, and an attractor may be selected for each portion. In another example, two or more attractors may be selected to strengthen an effect of the attractor(s) in guiding the crowd (e.g., the two or three attractors with highest social interaction forces may be selected). In some embodiments, the server 420 may be configured to periodically or dynamically re-identify crowd attractors as the crowd model 418 is updated. For example, the social force extraction module 422 may be configured to extract new social interaction forces from the updated crowd model 418, and the attractor force evaluator module 424 may be configured to re-sum the new social interaction forces. The server 420 may then use the re-summed social interaction forces to identify new attractors, which may include individuals previously identified as attractors as well as new individuals.

The server 420 may then provide the identified attractors to a server 426, which may be configured to generate notification data to be sent to one or more notification devices 430, similar to the notification devices depicted in FIGS. 2 and 3. In some embodiments, the server 426 may implement a display composer 428 configured to generate a representation of the crowd indicating identified attractors. For example, the representation of the crowd may be a video stream, still image, or augmented reality scene of the crowd, or data intended to be turned into a representation at device 430, and the display composer 428 may tag or otherwise indicate attractors shown within the representation, for example via an overlay, a heat map of the crowd, and/or with one or more markers or icons. A heat map is a graphical representation of data where the individual values contained in a matrix are represented as colors. Fractal maps and tree maps may also be used as a similar system of color-coding to represent the values taken by a variable in a hierarchy. In an example scenario, the heat map of the crowd may indicate density of the crowd using a color scheme (e.g., denser segments in red, sparse segments in blue, etc.) along with the attractor(s) being indicated using a distinct color (e.g., white). The display composer 428 may then provide the generated crowd representation indicating attractors to the notification device(s) 430, allowing security personnel to guide or instruct the attractors accordingly. In some embodiments, the display composer 428 or the server 420 may also provide guidance instructions or indicators within or along with the crowd representation. The guidance instructions may be generated by the server 414, an external server or authority, and/or a local administrator with access to the crowd model 418 and/or the captured video data, and may indicate how identified attractors should proceed. In some embodiments, one or more of the notification devices 430 may be configured to present the generated crowd representation and/or the guidance instructions directly to the crowd, such that attractors within the crowd can identify themselves from the crowd representation and guide themselves accordingly.

While the system 400 is depicted as including at least four different servers 404, 414, 420, and 426, in other embodiments the functionality of the servers 404, 414, 420, and 426 may be divided among fewer or more servers or other computing devices. Similarly, while in the system 400 certain servers implement certain modules, in other embodiments modules may be implemented by other computing devices or across multiple computing devices. For example, barrier and crowd member information may be received directly from the capture device(s) 402 instead of from the server 404. Furthermore, the crowd model may be updated based on changing conditions associated with the crowd such as a number of individuals in the crowd, a density of individuals in the crowd, changes in the environment, and so on.

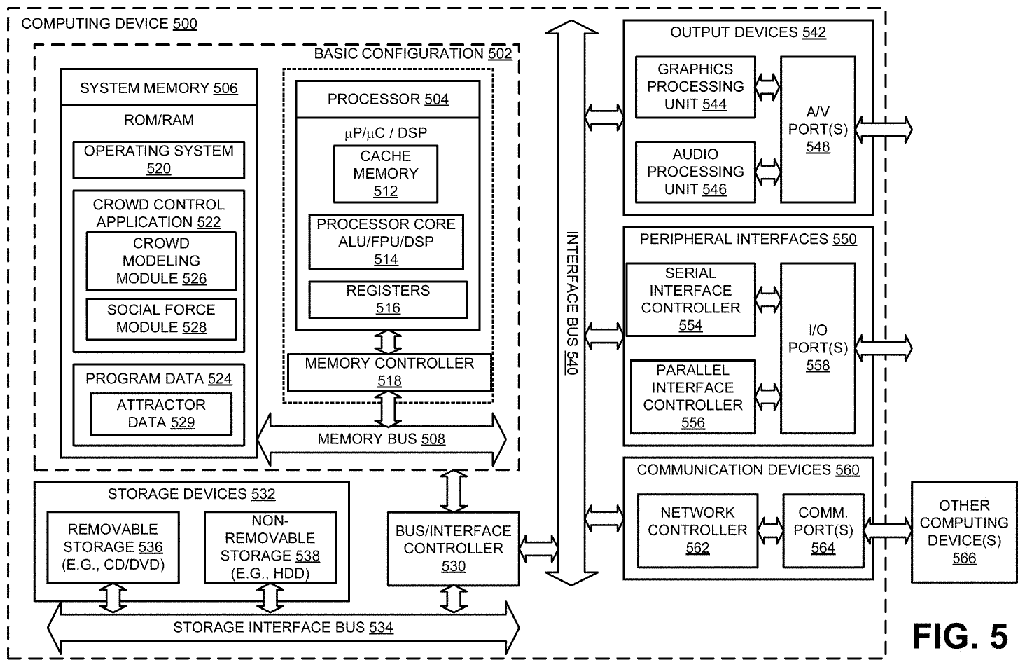

FIG. 5 illustrates a general purpose computing device, which may be used to identify and utilize attractors in crowd control, arranged in accordance with at least some embodiments described herein.

For example, the computing device 500 may be used to model crowds, determine social forces, and identify attractors as described herein. In an example basic configuration 502, the computing device 500 may include one or more processors 504 and a system memory 506. A memory bus 508 may be used to communicate between the processor 504 and the system memory 506. The basic configuration 502 is illustrated in FIG. 5 by those components within the inner dashed line.

Depending on the desired configuration, the processor 504 may be of any type, including but not limited to a microprocessor (μP), a microcontroller (μC), a digital signal processor (DSP), or any combination thereof. The processor 504 may include one or more levels of caching, such as a cache memory 512, a processor core 514, and registers 516. The example processor core 514 may include an arithmetic logic unit (ALU), a floating point unit (FPU), a digital signal processing core (DSP Core), or any combination thereof. An example memory controller 518 may also be used with the processor 504, or in some implementations the memory controller 518 may be an internal part of the processor 504.

Depending on the desired configuration, the system memory 506 may be of any type including but not limited to volatile memory (such as RAM), non-volatile memory (such as ROM, flash memory, etc.) or any combination thereof. The system memory 506 may include an operating system 520, a crowd control application 522, and program data 524. The crowd control application 522 may include a crowd modeling module 526 to perform crowd modeling, and a social force module 528 to determine social forces between individuals within a crowd, as described herein. The crowd control application 522 using the modules described herein and/or additional ones may extract social interaction forces for at least some individuals in the crowd and use the social interaction forces to identify attractors, which may be those individuals with the social interaction forces above a predefined threshold under one or more various forms of evaluation (e.g., summation, weighted summation, averaging, sum of forces that meet certain criteria, etc.). The program data 524 may include, among other data, attractor data 529 or the like, as described herein.

The computing device 500 may have additional features or functionality, and additional interfaces to facilitate communications between the basic configuration 502 and any desired devices and interfaces. For example, a bus/interface controller 530 may be used to facilitate communications between the basic configuration 502 and one or more data storage devices 532 via a storage interface bus 534. The data storage devices 532 may be one or more removable storage devices 536, one or more non-removable storage devices 538, or a combination thereof. Examples of the removable storage and the non-removable storage devices include magnetic disk devices such as flexible disk drives and hard-disk drives (HDDs), optical disk drives such as compact disc (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

The system memory 506, the removable storage devices 536 and the non-removable storage devices 538 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 500. Any such computer storage media may be part of the computing device 500.

The computing device 500 may also include an interface bus 540 for facilitating communication from various interface devices (e.g., one or more output devices 542, one or more peripheral interfaces 550, and one or more communication devices 560) to the basic configuration 502 via the bus/interface controller 530. Some of the example output devices 542 include a graphics processing unit 544 and an audio processing unit 546, which may be configured to communicate to various external devices such as a display or speakers via one or more A/V ports 548. One or more example peripheral interfaces 550 may include a serial interface controller 554 or a parallel interface controller 556, which may be configured to communicate with external devices such as input devices (e.g., keyboard, mouse, pen, voice input device, touch input device, etc.) or other peripheral devices (e.g., printer, scanner, etc.) via one or more I/O ports 558. An example communication device 560 includes a network controller 562, which may be arranged to facilitate communications with one or more other computing devices 566 over a network communication link via one or more communication ports 564. The one or more other computing devices 566 may include servers at a datacenter, customer equipment, and comparable devices.

The network communication link may be one example of a communication media. Communication media may be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 500 may be implemented as a part of a general purpose or specialized server, mainframe, or similar computer that includes any of the above functions. The computing device 500 may also be implemented as a personal computer including both laptop computer and non-laptop computer configurations.

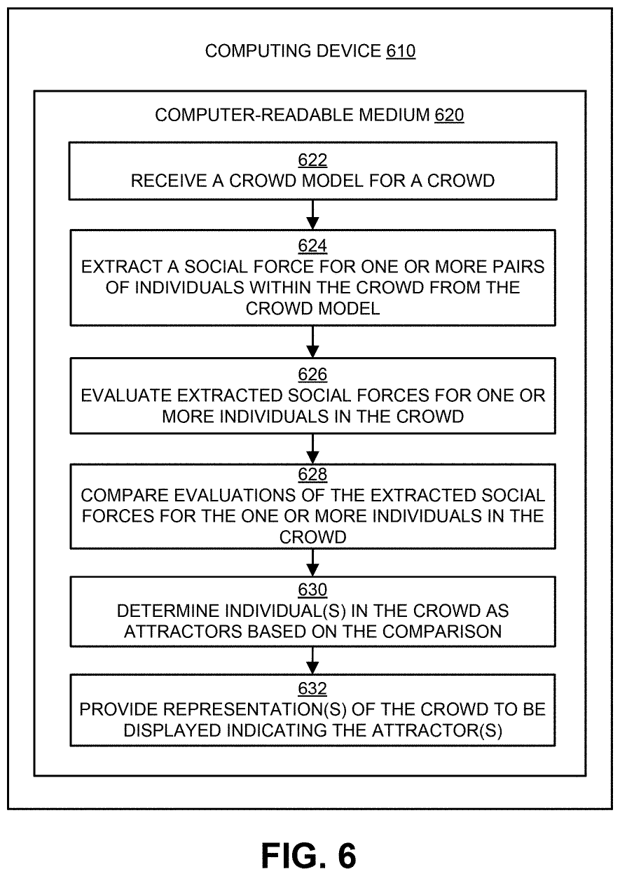

FIG. 6 is a flow diagram illustrating an example method to identify and utilize attractors in crowd control that may be performed by a computing device such as the computing device in FIG. 5, arranged in accordance with at least some embodiments described herein.

Example methods may include one or more operations, functions or actions as illustrated by one or more of blocks 622, 624, 626, and/or 628, and may in some embodiments be performed by a computing device such as the computing device 600 in FIG. 6. The operations described in the blocks 622-628 may also be stored as computer-executable instructions in a computer-readable medium such as a computer-readable medium 620 of a computing device 610.

An example process to identify and utilize attractors in crowd control may begin with block 622, “RECEIVE A CROWD MODEL FOR A CROWD”, where a crowd monitoring and control system as described above may receive a crowd model for a crowd within a monitored travel paths or area. The crowd model may be based on combining mechanical and social interaction forces on individuals in the crowd, as described above. In some embodiments, the system may generate the crowd model based on captured image or video information, barrier information, crowd member information, location map information, and/or any other suitable data.

Block 622 may be followed by block 624, “EXTRACT A SOCIAL FORCE FOR ONE OR MORE PAIRS OF INDIVIDUALS WITHIN THE CROWD FROM THE CROWD MODEL”, where a social force extraction module such as the social force extraction module 422 may extract social interaction forces between some individuals in the crowd and each other relevant individual in the crowd may be extracted from the crowd model, as described above.

Block 624 may be followed by block 626, “EVALUATE EXTRACTED SOCIAL FORCES FOR ONE OR MORE INDIVIDUALS IN THE CROWD”, where an attractor force evaluator module such as the attractor force evaluator module 424 may sum or otherwise evaluate the social interaction forces associated with one or more individuals and extracted in block 624, as described above.

Block 626 may be followed by block 628, “COMPARE EVALUATIONS OF THE EXTRACTED SOCIAL FORCES FOR THE ONE OR MORE INDIVIDUALS IN THE CROWD”, where a server may compare the evaluated social interaction forces for one or more individuals in the crowd with each other to determine those individuals with the highest social interaction forces sums, as described above.

Block 628 may be followed by block 630, “DETERMINE INDIVIDUAL(S) IN THE CROWD AS ATTRACTORS BASED ON THE COMPARISON”, where the server may select from among the individuals identified with higher social interaction forces as crowd attractors, as described above.

Block 630 may be followed by block 632, “PROVIDE REPRESENTATION(S) OF THE CROWD TO BE DISPLAYED INDICATING THE ATTRACTOR(S)”, where a display composer such as the display composer 428 may generate still images or video streams or other representations of the crowd that indicate the identified attractors (for example, via tags, icons, and/or a heat map) and provide the generated representations to notification devices to be displayed, as described above.

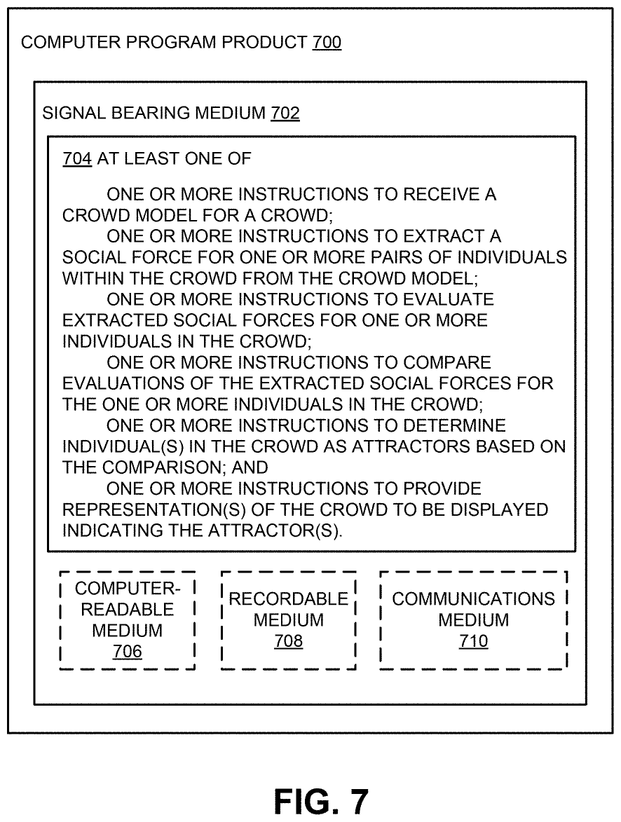

FIG. 7 illustrates a block diagram of an example computer program product, arranged in accordance with at least some embodiments described herein.

In some examples, as shown in FIG. 7, a computer program product 700 may include a signal bearing medium 702 that may also include one or more machine readable instructions 704 that, when executed by, for example, a processor may provide the functionality described herein. Thus, for example, referring to the processor 504 in FIG. 5, the crowd control application 522 may undertake one or more of the tasks shown in FIG. 7 in response to the instructions 704 conveyed to the processor 504 by the signal bearing medium 702 to perform actions associated with identifying and utilizing attractors in crowd control as described herein. Some of those instructions may include, for example, instructions to receive a crowd model for a crowd, extract a social force for one or more pairs of individuals within the crowd from the crowd model, evaluate extracted social forces for one or more individuals in the crowd, compare evaluations of the extracted social forces for the one or more individuals in the crowd, determine individual(s) in the crowd as attractors based on the comparison, and/or provide image(s) of the crowd to be displayed indicating the attractor(s), according to some embodiments described herein.

In some implementations, the signal bearing medium 702 depicted in FIG. 7 may encompass computer-readable medium 706, such as, but not limited to, a hard disk drive (HDD), a solid state drive (SSD), a compact disc (CD), a digital versatile disk (DVD), a digital tape, memory, etc. In some implementations, the signal bearing medium 702 may encompass recordable medium 708, such as, but not limited to, memory, read/write (R/W) CDs, R/W DVDs, etc. In some implementations, the signal bearing medium 702 may encompass communications medium 710, such as, but not limited to, a digital and/or an analog communication medium (e.g., a fiber optic cable, a waveguide, a wired communication link, a wireless communication link, etc.). Thus, for example, the computer program product 700 may be conveyed to one or more modules of the processor 504 by an RF signal bearing medium, where the signal bearing medium 702 is conveyed by the communications medium 710 (e.g., a wireless communications medium conforming with the IEEE 802.11 standard).

According to some examples, a method is provided to detect and use attractors in crowd control. The method may include receiving a crowd model for a crowd, extracting a social force for one or more pairs of individuals within the crowd from the crowd model, evaluating extracted social forces for one or more individuals in the crowd, and comparing the evaluated social forces for the one or more individuals in the crowd. The method may further include determining a subset of individuals in the crowd as attractors based on the comparison and providing one or more representations of the crowd to be displayed, where the attractors are indicated in the one or more representations.

According to some embodiments, providing the images of the crowd to be displayed may include providing a video stream of the crowd. The method may further include indicating the one or more determined attractors by tagging the attractors in the one or more images and/or generating a heat map that represents a density of the crowd and the attractors in the one or more images. The method may further include receiving an instruction to guide at least one of the attractors and providing the instruction to the attractor(s) through a display device. Providing the instruction may include displaying the instruction on an augmented reality scene of the crowd. The display device may be a smart phone, a public display, a wearable computer, and/or a tablet computer. The method may further include determining a compliance of the attractor(s) with the provided instruction and providing feedback to a crowd model computation model based on the determined compliance. The method may further include receiving an updated crowd model, extracting a new social force for the one or more pairs of individuals within the crowd from the updated crowd model, and determining one or more new individuals as attractors in the crowd.

According to other examples, a system is provided for detection and use of attractors in crowd control. The system may include a first server, where the first server includes a communication module configured to exchange data with one or more computing devices, a memory configured to store instructions, and a processor coupled to the communication module and the memory. The processor may be configured to execute a crowd control application in conjunction with the instructions stored in the memory. The crowd control application may be configured to receive a crowd model for a crowd and iteratively extract a social force for one or more pairs of individuals within the crowd from the crowd model. The crowd control application may be further configured to determine a subset of individuals in the crowd as attractors based on a comparison of a sum of extracted social forces for one or more individuals in the crowd and provide one or more representations of the crowd to be displayed, where the attractors are indicated in the one or more representations.

According to some embodiments, the crowd control application may be configured to provide the image(s) of the crowd to be displayed by providing a video stream of the crowd, providing selected still image(s) of the crowd, or providing a heat map of the crowd. The attractors may be indicated through tagging or heat map indication.

According to other embodiments, the system may further include a second server. The second server may include a communication module configured to exchange data with one or more computing devices, a memory configured to store instructions, and a processor coupled to the communication module and the memory, where the processor may be configured to execute a crowd modeling application in conjunction with the instructions stored in the memory. The crowd modeling application may be configured to receive barrier information, crowd member information, and location information associated with the crowd and an environment of the crowd. The crowd modeling application may be further configured to generate the crowd model based on the received barrier information, crowd member information, and location information, where the crowd model may include a social force for the one or more individuals in the crowd.

According to further embodiments, the crowd modeling application may be configured to determine the social force for the one or more individuals in the crowd based on a self-drive force of the one or more individuals, a sum of interaction forces from other individuals on the one or more individuals, and a sum of barrier forces on the one or more individuals. The crowd modeling application may be configured to receive the barrier information and the crowd member information from one or more image capture devices. The crowd modeling application may be configured to receive the location information from a map database, and may be configured to generate the crowd model based on a best-fit model.

According to further examples, a crowd control system configured to provide detection and use of attractors in crowd control is provided. The system may include multiple monitoring devices configured to capture images of a crowd. The system may further include a server configured to receive barrier information, crowd member information, and location information associated with the crowd and an environment of the crowd. The server may be further configured to generate a crowd model based on the received barrier information, crowd member information, and location information, where the crowd model includes a social force for one or more individuals in the crowd. The server may be further configured to extract the social force for one or more pairs of individuals within the crowd from the crowd model, determine a subset of individuals in the crowd as attractors based on a comparison of a sum of extracted social forces for the one or more individuals in the crowd, and provide one or more images of the crowd to be displayed, where the attractors are tagged in the one or more images.

According to some embodiments, the crowd control system may further include one or more display devices configured to display instructions to the attractors. The server may be further configured to provide the image(s) of the crowd to be displayed to an administrator, receive the instructions to guide the attractors from the administrator, and provide the instructions to the display device(s). The server may be further configured to determine the social forces based on a sum of a self-drive force for each of the one or more individuals in the crowd, an interactive force applied to each of the one or more individuals by other individuals in the crowd iteratively summed for all interacting individuals, and a barrier force applied to each of the one or more individuals by natural and synthetic barriers in the environment of the crowd iteratively summed for all barriers.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for mainly hardware and/or firmware vehicle; if flexibility is paramount, the implementer may opt for mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via application specific integrated circuits (ASICs), field programmable gate arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs executing on one or more computers (e.g., as one or more programs executing on one or more computer systems), as one or more programs executing on one or more processors (e.g., as one or more programs executing on one or more microprocessors), as firmware, or as virtually any combination thereof, and that designing the circuitry and/or writing the code for the software and/or firmware would be well within the skill of one of skill in the art in light of this disclosure.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive (HDD), a compact disc (CD), a digital versatile disk (DVD), a digital tape, a computer memory, a solid state drive (SSD), etc.; and a transmission type medium such as a digital and/or an analog communication medium (e.g., a fiber optic cable, a waveguide, a wired communication link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a data processing system may include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity of gantry systems; control motors to move and/or adjust components and/or quantities).

A data processing system may be implemented utilizing any suitable commercially available components, such as those found in data computing/communication and/or network computing/communication systems. The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no, such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method to detect and use attractors in crowd control, the method comprising:
receiving a crowd model for a crowd;
extracting, from the crowd model, one or more parameters associated with a plurality of social forces, wherein each of the one or more parameters indicates whether one or more individuals in the crowd are subject to social forces to follow activity of another of the one or more individuals in the crowd;
evaluating activity of the one or more individuals in the crowd;
comparing the evaluated activity to the one or more extracted parameters to identify one or more of the plurality of social forces;
determining a subset of individuals in the crowd as attractors based on the comparison; and
providing one or more images of the crowd to be displayed to security personnel, wherein the attractors are indicated in the one or more images.

2. The method of claim 1, wherein providing the one or more images of the crowd to be displayed comprises providing a video stream of the crowd.

3. The method of claim 1, further comprising indicating the one or more determined attractors by tagging the attractors in the one or more images.

4. The method of claim 1, further comprising generating a heat map that represents a density of the crowd and the attractors in the one or more images.

5. The method of claim 1, further comprising:
receiving an instruction to guide at least one of the attractors; and
providing the instruction to the at least one of the attractors through a display device.

6. The method of claim 5, wherein providing the instruction to the at least one of the attractors comprises displaying the instruction on an augmented reality scene of the crowd.

7. The method of claim 5, wherein providing the instruction to the at least one of the attractors through the display device is comprises causing the instruction to be displayed through one or more of a smart phone, a public display, a wearable computer, and a tablet computer.

8. The method of claim 5, further comprising:
determining a compliance of the at least one of the attractors with the provided instruction; and
providing feedback to a crowd model computation module based on the determined compliance.

9. (canceled)

10. A system to detect and use attractors in crowd control, the system comprising:
a first server comprising:
a communication module configured to exchange data with one or more computing devices;
a memory configured to store instructions; and
a processor coupled to the communication module and the memory, the processor configured to execute a crowd control application in conjunction with the instructions stored in the memory, wherein the crowd control application is configured to:
receive a crowd model for a crowd;
iteratively extract, from the crowd model, one or more parameters associated with a plurality of social forces, wherein each one of the one or more parameters indicates whether one or more individuals in the crowd are subject to social forces to follow activity of another of the one or more individuals in the crowd;
evaluate activity of the one or more individuals in the crowd;
compare the evaluated activity to the one or more extracted parameters to identify one or more of the plurality of social forces;
determine a subset of individuals in the crowd as attractors based on the comparison; and
provide one or more images of the crowd to be displayed to security personnel, wherein the attractors are indicated in the one or more images.

11. The system of claim 10, wherein the crowd control application is configured to provide the one or more images of the crowd to be displayed as one of:
a video stream of the crowd;
one or more selected still images of the crowd; and
a heat map of the crowd.

12. The system of claim 11, wherein the attractors are indicated through one of tagging and heat map indication.

13. The system of claim 10, further comprising:
a second server comprising:
a communication module configured to exchange data with one or more computing devices;
a memory configured to store instructions; and
a processor coupled to the communication module and the memory, the processor configured to execute a crowd modeling application in conjunction with the instructions stored in the memory, wherein the crowd modeling application is configured to:
receive barrier information, crowd member information, and location information associated with the crowd and an environment of the crowd; and
generate the crowd model based on the received barrier information, crowd member information, and location information, wherein the crowd model includes the one or more parameters associated with the plurality of social forces.

14. The system of claim 13, wherein the crowd modeling application is configured to identify the plurality of social forces based on a self-drive force of the one or more individuals, a sum of interaction forces from other individuals on each of the one or more individuals, and a sum of barrier forces on each of the one or more individuals.

15. The system of claim 13, wherein the crowd modeling application is configured to receive the barrier information and the crowd member information from one or more image capture devices.

16. The system of claim 13, wherein the crowd modeling application is configured to receive the location information from a map database.

17. The system of claim 13, wherein the crowd modeling application is configured to generate the crowd model based on a best-fit model.

18. A crowd control system configured to provide detection and use of attractors in crowd control, the system comprising:
a plurality of monitoring devices configured to capture images of a crowd;
a server configured to:
receive barrier information, crowd member information, and location information associated with the crowd and an environment of the crowd;
generate a crowd model based on the received barrier information, crowd member information, and location information, wherein the crowd model includes one or more parameters associated with a plurality of social forces, wherein each of the one or more parameters indicate whether one or more individuals in the crowd are subject to social forces to follow activity of another of the one or more individuals in the crowd;
extract, from the crowd model, the one or more parameters associated with the plurality of individuals within the crowd;
compare the evaluated activity to the one or more extracted parameters to identify one or more of the plurality of social forces;
determine a subset of individuals in the crowd as attractors based on the comparison; and
provide one or more images of the crowd to be displayed, wherein the attractors are tagged in the one or more images.

19. The crowd control system of claim 18, further comprising:
one or more display devices configured to display instructions to the attractors.

20. The crowd control system of claim 19, wherein the server is further configured to:
provide the one or more images of the crowd to be displayed to an administrator;
receive the instructions to guide the attractors from the administrator; and
provide the instructions to the one or more display devices.

21. The crowd control system of claim 18, wherein the server is further configured to identify the social forces based on a sum of a self-drive force for each of the one or more individuals in the crowd, an interactive force applied to each of the one or more individuals by other individuals in the crowd iteratively summed for all interacting individuals, and a barrier force applied to each of the one or more individuals by natural and synthetic barriers in the environment of the crowd iteratively summed for all barriers.

22. (canceled)

23. (canceled)

24. The crowd control system of claim 18, wherein the crowd model includes one or more of a number of individuals in the crowd, a direction of each individual in the crowd, a speed of each individual in the crowd, a density of the individuals in the crowd, a visibility in a crowd environment, a general direction of the crowd, and one or more of a location, a size, and a type of barriers in the crowd environment.
